(19) United States
(12) Patent Application Publication
(10) Pub. No.: US 2013/0021597 A1
(43) Pub. Date: Jan. 24, 2013

(54) CABLE IDENTIFICATION

(71) Applicants: William G. Carlson, JR., Hopewell Junction, NY (US); George T. Galyon, Fishkill, NY (US); Osvaldo A. Rodriguez, Poughkeepsie, NY (US); Eric C. Wieder, New Paltz, NY (US)

(72) Inventors: William G. Carlson, JR., Hopewell Junction, NY (US); George T. Galyon, Fishkill, NY (US); Osvaldo A. Rodriguez, Poughkeepsie, NY (US); Eric C. Wieder, New Paltz, NY (US)

(73) Assignee: INTERNATIONAL BUSINESS MACHINES CORPORATION, Armonk, NY (US)

(21) Appl. No.: 13/187,609

(22) Filed: Jul. 21, 2011

(51) Int. Cl. G01N 21/00

(52) U.S. Cl. 356/73.1

(57) ABSTRACT

A storage area network cable apparatus can include a cable, an identification adaptor disposed in the cable, an illuminator disposed in the identification adaptor, an endpoint adaptor disposed at an end of the cable and an integrated device disposed in the endpoint adapter and configured to generate a frequency in the cable.

### BACKGROUND

The present invention relates to cables such as storage area network (SAN) cables, and more specifically, to systems and methods for identifying cables.

A typical redundant SAN cable configuration for availability and to allow sufficient bandwidth from the compute endpoint to the storage is on the order of 4, 8, 16, 32, or 64 paths from the compute endpoint fiber channel (FC) ports to the SAN switch to the storage FC ports. To illustrate the number of cables involved consider the number of cables required for the sixteen path case. In this case, there can be sixteen paths, four compute endpoints, four disk storage ports, eight SAN switch ports (four in, four out), eight passive patch panel connections, resulting in sixteen total cables. This example is for one compute endpoint/disk storage endpoint. Current data centers that can have hundreds and sometimes thousands of compute endpoints, implies from the previous example up to 16,000 cables. This problem is exacerbated when test or hardware “push pull” or hardware replacement is taken into account. These are typical frequent operations in the data center (monthly if not more frequently).

Current identification techniques involve manually labeling cables, which is time consuming. Labels can fall off when cables are routed, providing another identification problem. Once placed, identifying certain groupings of cables can be very difficult, particularly if any of the cables are unplugged. Cables in passive connection can also be difficult to identify. Issues can also arise if a user is diagnosing a loose or faulty cable. Typically each cable must be removed and inspected by hand one at a time in a trial and error process. If the wrong cable is disconnected then potential disruption It also does not integrate well with other procedures for the data center like cable inventory and tracking. Further identification techniques include placing an addition “rope light” on the cable, in which a button can be depressed to illuminate the “rope light”.

### SUMMARY

Exemplary embodiments include a cable apparatus, including a cable, an identification adaptor disposed in the cable, an illuminator disposed in the identification adaptor, an endpoint adaptor disposed at an end of the cable and an integrated device disposed in the endpoint adapter and configured to generate a frequency in the cable.

Additional embodiments include a cable system, including a first device, a first endpoint adapter coupled to the first device, a first integrated device disposed in the first endpoint adapter and configured to generate a first frequency in the cable, a cable coupled to the first endpoint adapter, a first identification adaptor disposed in the cable and a first illuminator disposed in the identification adapter.

Further embodiments include a cable identification method, including sending a data transmission mode command to generate a data transmission mode frequency in the cable, sending and transmitting data with the data transmission mode frequency in the cable, sending an identify mode command to generate an identify mode frequency in the cable and terminating sending and transmitting data in response to generating the identify mode frequency in the cable.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an example of an exemplary SAN cable identification system;

FIG. 2 illustrates another example of an exemplary SAN cable identification system;

FIG. 3 illustrates another example of an exemplary SAN cable identification system;

FIG. 4 illustrates an exemplary SAN cable apparatus;

FIG. 5 illustrates an exemplary SAN cable apparatus;

FIG. 6 illustrates a flow chart for a method for identifying a cable in accordance with exemplary embodiments; and

FIG. 7 illustrates an exemplary embodiment of a system for identifying SAN cables.

### DETAILED DESCRIPTION

Exemplary embodiments include systems and methods for identifying cables. Throughout the disclosure, SAN cables are discussed for illustrative purposes. It will be appreciated that the systems and methods described herein can also be implemented to identify any cable type. The exemplary systems and methods described herein enable identification of cables regardless of how the cables are connected to the system. As such, the systems and methods described herein identify SAN cables that are either plugged and active or not plugged and inactive. Identification can be implemented for initial correct placement, when hardware components are replaced repaired or upgraded, and for debugging problems related to the SAN cables. Illuminators that are integrated into the cables are illuminated not only to indicate that the cable is connected, but also whether or not the cable is in a data transmission mode or an identify mode. The illuminators can be any device such as a colorimeter that is responsive to a light frequency and will illuminate in response to a frequency. A colorimeter can include a solution through which the light passes and a detector to detect the light. Various filters can be implemented to emit different colors of light. As such, the systems and methods described herein can provide a data transmission mode frequency that causes the illuminators to emit a first color and a indentify mode frequency that causes the illuminators to emit a second color, as described further herein.

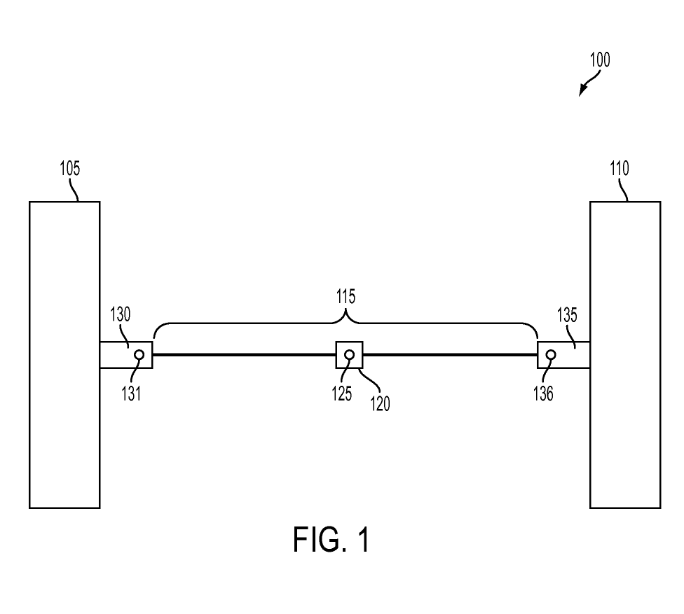

FIG. 1 illustrates an example of an exemplary SAN cable identification system 100. The system 100 can include a first SAN device 105 and a second SAN device 110. It can be appreciated that the first SAN device 105 and the second SAN device 110 can be any device in a SAN system. It can also be appreciated that a simplified system is shown for illustrative purposes. In the example shown in FIG. 1, the first SAN device 105 can be but is not limited to a SAN server, a SAN switch, which can be further connected to a series of SAN severs (not shown), or a SAN computer adapter. In the example, the second SAN device 110 can be but is not limited to a SAN switch or a storage device/disk. The system 100 can further include an exemplary SAN cable 115, that includes an exemplary identification adapter 120 integrated with the cable 115. The identification adapter can also include an illuminator 125. The identification adapter 120 and the illuminator 125 are illustrated larger than the cable 115 for illustrative purposes. In exemplary embodiments, the identification adaptor 120 and the illuminator are integrated and in communication with the material of the fiber incorporated in the cable 115.

In exemplary embodiments, the illuminator 125 is responsive to one of a data transmission mode frequency or an identify mode frequency. Both the data transmission mode frequency and the identify mode frequency and supported by and propagate in the cable 115 along with any other typical data frequencies supported by and propagated in the cable 115 between the first SAN device 105 and the second SAN device 110. In exemplary embodiments, the illuminator can emit a different light color for each of the data transmission mode frequency and the identify mode frequency. For example, the data transmission mode frequency color can be red and the identify mode frequency can be green.

The system 100 can further include a first endpoint adapter 130 disposed between the cable 115 and the first SAN device 105, and a second endpoint adapter 135 disposed between the cable 115 and the second SAN device 110. The cable 115 is shown as one line for illustrative purposes. As further described herein, the cable 115 can include a fiber optic pair (for send and receive). Each pair on the cable 115 can plug into the respective first endpoint adapter 130 and second endpoint adapter 135. Each of the first endpoint adapter 130 and the second endpoint adapter 135 then plugs into the respective first SAN device 105 and second SAN device 110. For example, the first endpoint adapter 130 and the second endpoint adapter 135 can be a gigabit interface controller (GBIC) or any suitable small form factor pluggable (SFP) device. As such, each of the first endpoint adapter 130 and the second endpoint adapter 135 include connectors that interface directly with the respective first SAN device 105 and second SAN device 110 thereby coupling the cable 115 to the first SAN device 105 and the second SAN device 110. As further described herein, the first endpoint adapter 130 and the second endpoint adapter 135 can include an integrated device, such as but not limited to a tunable laser diode. The integrated device can receive signals from a controller, such as the first SAN device 105 to be excited to emit one of the data transmission mode frequency and the identify mode frequency. The data transmission mode frequency or the identify mode frequency is then, in turn, transmitted down the cable 115, thereby illuminating the illuminator 125 with the corresponding color (i.e., the data transmission mode frequency color or the identify mode frequency color).

As such, in the example shown in FIG. 1, if the system 100 is just one part of a larger SAN system with many more cables, and a user wants to identify the cable 115 from the other cables, the user can implement software in the corresponding controller associated with the cable 115 to send an identify signal to the cable, which in turn, excites the integrated device (e.g., the laser diode) in one of the first endpoint adapter 130 and the second endpoint adapter 135 to emit an identify mode frequency in the cable 115 so that the illuminator 125 emits the indentify mode frequency light (e.g., green). Once the user programs the system 100 to be in the identify mode, the user can then go to the area housing the larger system with multiple cables and simply look at the bunch of cables for the illuminating green light. The user then knows which of the bunch of cables, is the cable 115. In exemplary embodiments, each of the first endpoint adapter 130 and the second endpoint adapter 135 can include a respective illuminator 131, 136 as well in order to assist the user in the identification process. The illuminators 131, 136 can be responsive in the same way that the illuminator 125 is responsive to the data transmission mode frequency and the identify mode frequency as described herein.

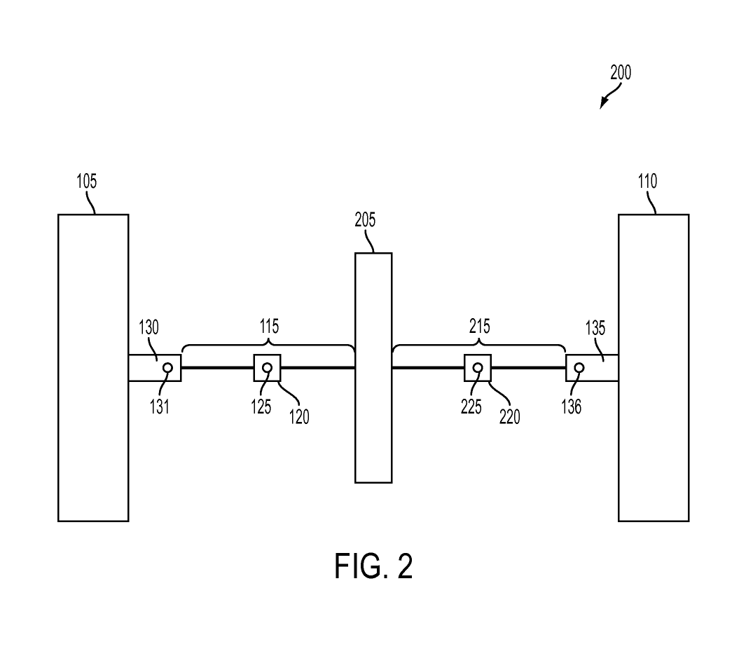

FIG. 2 illustrates an example of an exemplary SAN cable identification system 200. The system 200 is a similar system as the system 100 as in FIG. 1, with modifications to further illustrate exemplary embodiments. The system 200 can include the first SAN device 105 and a second SAN device 110. The system 200 can further include the exemplary SAN cable 115, that includes the exemplary identification adapter 120 integrated with the cable 115. The identification adapter can also include the illuminator 125.

The system 200 can further include the first endpoint adapter 130 disposed between the cable 115 and the first SAN device 105. However, in the system 200, the cable 115 is plugged directly into a passive SAN patch panel 205, which allows re-routing and re-using of SAN cables. The system 200 can further include an additional exemplary SAN cable 215 that includes an exemplary identification adapter 220 integrated with the cable 215. The identification adapter 220 can also include an illuminator 225. The additional cable 215 including the identification adapter 220 and the illuminator 225 have the same features as the cable 115, the identification adapter 120 and the illuminator 125 described herein. The system 200 further includes the second endpoint adapter 135 disposed between the cable 215 and the second SAN device 110. The cable 215 is further directly plugged into the passive SAN patch panel 205.

As such, in the example shown in FIG. 2, if the system 200 is just one part of a larger SAN system with many more cables, and a user wants to identify the cable 115 from the other cables, the user can implement software in the corresponding controller associated with the cable 115 to send an identify signal to the cable, which in turn, excites the integrated device (e.g., the laser diode) in the first endpoint adapter 130 to emit an identify mode frequency in the cable 115 so that the illuminator 125 emits the indentify mode frequency light (e.g., green). Alternatively, the user may want to identify the cable 215 from the other cables, the user can implement software in the corresponding controller associated with the cable 215 to send an identify signal to the cable, which in turn, excites the integrated device (e.g., the laser diode) in the second endpoint adapter 135 to emit an identify mode frequency in the cable 215 so that the illuminator 225 emits the indentify mode frequency light (e.g., green). It can be appreciated that each of the cables 115, 215 is separated from the other due to the passive SAN patch panel 205. As such, in order to identify one of the cables 115, 215, the integrated device in the respective endpoint adapter 130, 135 is excited. Regardless of the cable 115, 215 the user is to identify, once the user programs the system 200 to be in the identify mode for either cable 115, 215, the user can then go to the area housing the larger system with multiple cables and simply look at the bunch of cables for the illuminating green light. The user then knows which of the bunch of cables, is the cable 115, 215.

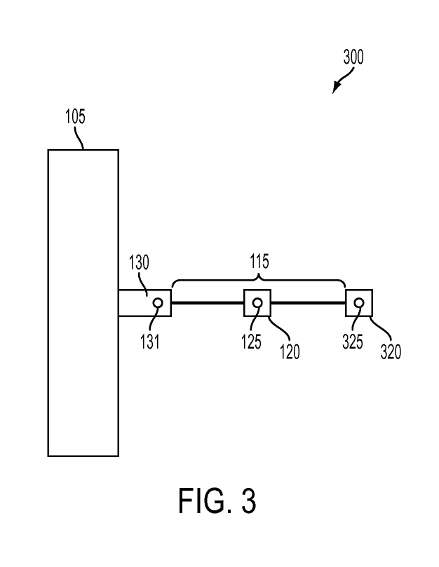

FIG. 3 illustrates an example of an exemplary SAN cable identification system 300. The system 300 is a similar system as the systems 100, 200 as in FIGS. 1 and 2, respectively, with modifications to further illustrate exemplary embodiments. The system 300 can include the first SAN and the exemplary SAN cable 115, that includes the exemplary identification adapter 120 integrated with the cable 115. The identification adapter can also include the illuminator 125.

The system 300 can further include the first endpoint adapter 130 disposed between the cable 115 and the first SAN device 105. However, in the system 200, the cable 115 is unplugged from any additional SAN device. In order to identify the cable 115, the system 300 can further include an exemplary removable end adapter 320 that includes an illuminator 325. The exemplary removable end adapter 320 and the illuminator 325 have the same features as the identification adapters 120, 220 and the illuminators 125, 225 described herein.

As such, in the example shown in FIG. 3, if the system 300 is just one part of a larger SAN system with many more cables, and a user wants to identify the cable 115 from the other cables, the user can implement software in the corresponding controller associated with the cable 115 to send an identify signal to the cable, which in turn, excites the integrated device (e.g., the laser diode) in the first endpoint adapter 130 to emit an identify mode frequency in the cable 115 so that the illuminator 125 emits the indentify mode frequency light (e.g., green). In this example, the cable 115 may be loose as shown or faulty, effectively behaving in the system 300 as if it were loose. Once the user programs the system 200 to be in the identify mode for the cable 115, the user can then go to the area housing the larger system with multiple cables and simply look at the bunch of cables for the illuminating green light. The user then knows which of the bunch of cables, is the cable 115.

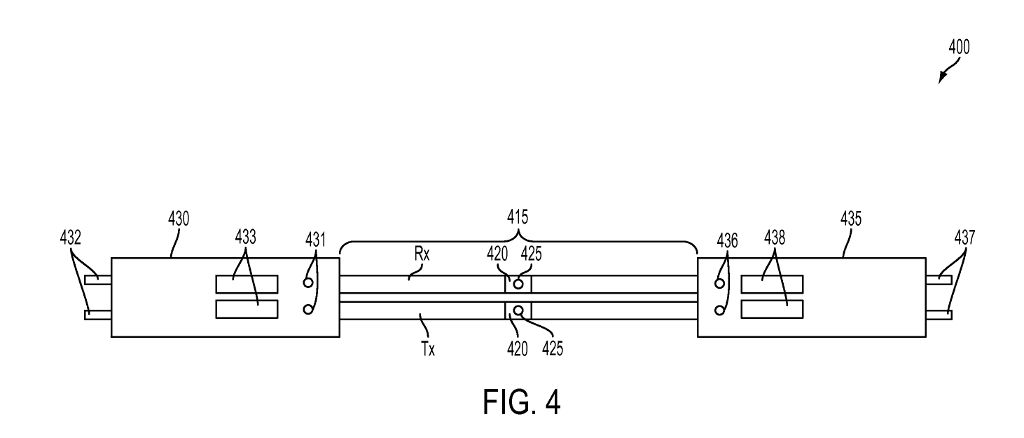

FIG. 4 illustrates an exemplary SAN cable apparatus 400. The apparatus 400 can include a cable 415 including an exemplary identification adapter 420 integrated with the cable 415. The identification adapter 420 can also include an illuminator 425. The cable 415 including the identification adapter 420 and the illuminator 425 have the same features as the cables 115, 215, the removable end adapter 320, the identification adapters 120, 220 and the illuminators 125, 225, 325 described herein. The apparatus 400 can further include a first endpoint adapter 430 disposed on one end of the cable 414 and a second endpoint adapter 435 disposed on an opposing end of the cable 415. As described herein, the cable 415 can include a fiber optic pair (for send and receive), and as such, an Rx and Tx portion are shown. As illustrated, each of the pairs Rx, Tx is shown having a respective identification adapter 420 and illuminator 425. It can be appreciated that one or both of the pairs Rx, Tx can include the identification adapter 420 and the illuminator 425. Each pair on the cable 415 can plug into the respective first endpoint adapter 430 and second endpoint adapter 435. Each of the first endpoint adapter 430 and the second endpoint adapter 435 then plugs into the respective SAN device as described herein. Each of the first endpoint adapter 430 and the second endpoint adapter 435 respectively includes connectors 432, 437 suitable for connecting to the respective SAN device thereby coupling the cable 415 to the respective SAN device.

As described herein, the first endpoint adapter 430 and the second endpoint adapter 435 can each include an integrated device 433, 438, such as but not limited to a tunable laser diode. The integrated device 433, 438 can receive signals from a controller, such as the first SAN server to be excited to emit one of the data transmission mode frequency and the identify mode frequency as described herein. The data transmission mode frequency or the identify mode frequency is then, in turn, transmitted down the cable 415, thereby illuminating the illuminator 425 with the corresponding color (i.e., the data transmission mode frequency color or the identify mode frequency color). As illustrated, each of the pairs Rx, Tx includes an associated integrated device 433, 438. It can be appreciated that one or both of the pairs Rx, Tx can include an associated integrated device 433, 438.

In exemplary embodiments, each of the first endpoint adapter 430 and the second endpoint adapter 435 can include a respective illuminator 431, 436 as well in order to assist the user in the identification process. The illuminators 431, 436 can be responsive in the same way that the illuminators 125, 225, 325, 425 are responsive to the data transmission mode frequency and the identify mode frequency as described herein.

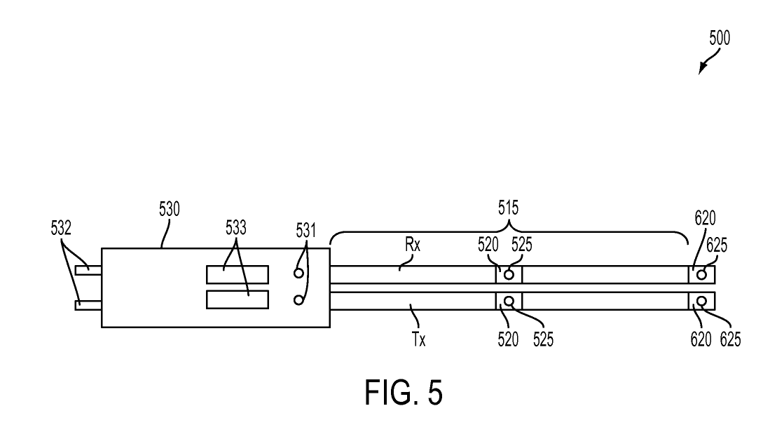

FIG. 5 illustrates an exemplary SAN cable apparatus 500. The apparatus 500 can include a cable 515 including an exemplary identification adapter 520 integrated with the cable 515. The identification adapter 520 can also include an illuminator 525. The cable 515 including the identification adapter 520 and the illuminator 525 have the same features as the cables 115, 215, 415 the removable end adapter 320, the identification adapters 120, 220, 420 and the illuminators 125, 225, 325, 425 described herein. The apparatus 500 can further include a first endpoint adapter 530 disposed on one end of the cable 515. As described herein, the cable 515 can include a fiber optic pair (for send and receive), and as such, an Rx and Tx portion are shown. As illustrated, each of the pairs Rx, Tx is shown having a respective identification adapter 520 and illuminator 525. It can be appreciated that one or both of the pairs Rx, Tx can include the identification adapter 520 and the illuminator 525. Each pair on the cable 515 can plug into the first endpoint adapter 530. The first endpoint adapter 530 then plugs into a respective SAN device as described herein. The first endpoint adapter 530 includes connectors 532 suitable for connecting to the respective SAN device thereby coupling the cable 515 to the respective SAN device.

As shown in the example in FIG. 5, the cable 515 is unplugged from any additional SAN device. In order to identify the cable 515, the system 500 can further include an exemplary removable end adapter 620 that includes an illuminator 625. The exemplary removable end adapter 620 and the illuminator 625 have the same features as the identification adapters 120, 220, 420, 520, the removable end adapter 320, and the illuminators 125, 225, 325, 425, 525 described herein.

As described herein, the first endpoint adapter 530 can include an integrated device 533, such as but not limited to a tunable laser diode. The integrated device 533 can receive signals from a controller, such as the first SAN server to be excited to emit one of the data transmission mode frequency and the identify mode frequency as described herein. The data transmission mode frequency or the identify mode frequency is then, in turn, transmitted down the cable 515, thereby illuminating the illuminator 525 with the corresponding color (i.e., the data transmission mode frequency color or the identify mode frequency color), and also the illuminator 625. As illustrated, each of the pairs Rx, Tx includes an associated integrated device 533. It can be appreciated that one or both of the pairs Rx, Tx can include an associated integrated device 533.

In exemplary embodiments, the first endpoint adapter 530 can include a respective illuminator 531 as well in order to assist the user in the identification process. The illuminators 531 can be responsive in the same way that the illuminators 125, 225, 325, 425, 525 are responsive to the data transmission mode frequency and the identify mode frequency as described herein.

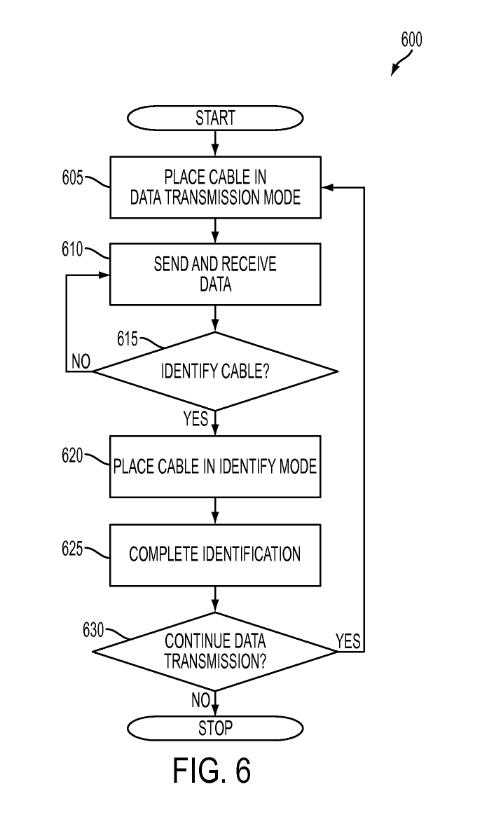

FIG. 6 illustrates a flow chart for a method 600 for identifying a cable in accordance with exemplary embodiments. At block 605, the cable can be placed in a data transmission mode. As described herein, the user can direct the tunable diodes to generate a frequency that causes one of the exemplary illuminators disposed on the cable to emit a color indicative of the data transmission mode. At block 610, data can be sent and received as in any operating mode of the SAN system. At block 615, a user can determine whether there is a need to place the cable in an identify mode. If there is not reason to place the cable in identify mode at block 615, then the method 600 continues at block 610. If there is a reason to place the cable in identify mode at block 615, then at block 620, the user can place the cable in identify mode. As described herein, the user can direct the tunable diodes to generate a frequency that causes one of the exemplary illuminators disposed on the cable to emit a color indicative of the identify mode. At block 625, the user can provide any functions that required the identify mode and then complete the identification process. At block 630, the user can decide to continue data transmission in the SAN system. If at block 630, the user decides to continue data transmission, then the method 600 continues at block 605. If at block 630, the user decides not to continue data transmission, then the method 600 ceases.

SAN controllers have been generally described herein. It is appreciated that any suitable computing system can be implemented to generate the commands and signals to generate the data transmission mode frequency and the identify mode frequency.

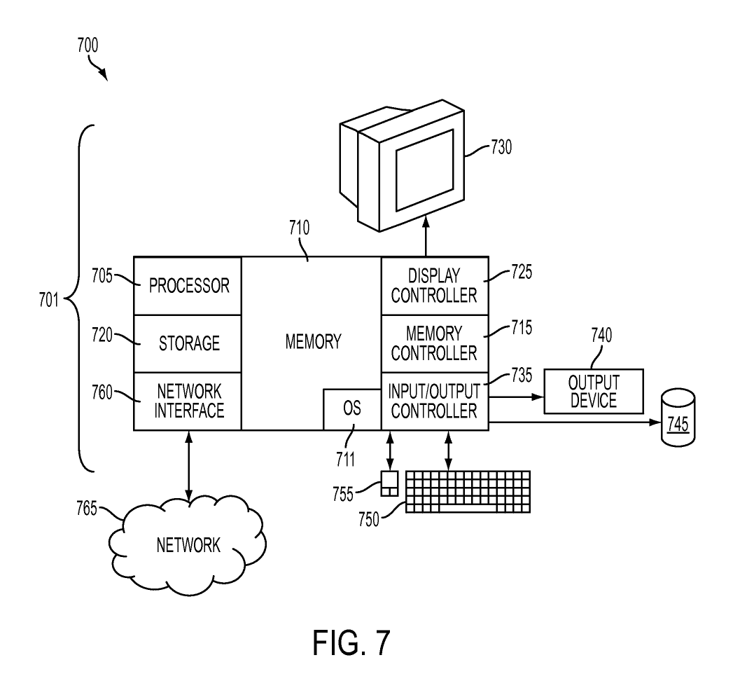

FIG. 7 illustrates an exemplary embodiment of a system 700 for identifying SAN cables. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 700 therefore includes general-purpose computer 701.

In exemplary embodiments, in terms of hardware architecture, as shown in FIG. 7, the computer 701 includes a processor 705, memory 710 coupled to a memory controller 715, and one or more input and/or output (I/O) devices 740, 745 (or peripherals) that are communicatively coupled via a local input/output controller 735. The input/output controller 735 can be, but is not limited to, one or more buses or other wired or wireless connections, as is known in the art. The input/output controller 735 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 705 is a hardware device for executing software, particularly that stored in memory 710. The processor 705 can be any custom made or commercially available processor, a central processing unit (CPU), an auxiliary processor among several processors associated with the computer 701, a semiconductor based microprocessor (in the form of a microchip or chip set), a macroprocessor, or generally any device for executing software instructions.

The memory 710 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 710 may incorporate electronic, magnetic, optical, and/or other types of storage media. Note that the memory 710 can have a distributed architecture, where various components are situated remote from one another, but can be accessed by the processor 705.

The software in memory 710 may include one or more separate programs, each of which comprises an ordered listing of executable instructions for implementing logical functions. In the example of FIG. 7, the software in the memory 710 includes the SAN cable identification methods described herein in accordance with exemplary embodiments and a suitable operating system (OS) 711. The OS 711 essentially controls the execution of other computer programs, such the SAN cable identification systems and methods as described herein, and provides scheduling, input-output control, file and data management, memory management, and communication control and related services.

The SAN cable identification methods described herein may be in the form of a source program, executable program (object code), script, or any other entity comprising a set of instructions to be performed. When a source program, then the program needs to be translated via a compiler, assembler, interpreter, or the like, which may or may not be included within the memory 710, so as to operate properly in connection with the OS 711. Furthermore, the SAN cable identification methods can be written as an object oriented programming language, which has classes of data and methods, or a procedure programming language, which has routines, subroutines, and/or functions.

In exemplary embodiments, a conventional keyboard 750 and mouse 755 can be coupled to the input/output controller 735. Other output devices such as the I/O devices 740, 745 may include input devices, for example but not limited to a printer, a scanner, microphone, and the like. Finally, the I/O devices 740, 745 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 700 can further include a display controller 725 coupled to a display 730. In exemplary embodiments, the system 700 can further include a network interface 760 for coupling to a network 765. The network 765 can be an IP-based network for communication between the computer 701 and any external server, client and the like via a broadband connection. The network 765 transmits and receives data between the computer 701 and external systems. In exemplary embodiments, network 765 can be a managed IP network administered by a service provider. The network 765 may be implemented in a wireless fashion, e.g., using wireless protocols and technologies, such as WiFi, WiMax, etc. The network 765 can also be a packet-switched network such as a local area network, wide area network, metropolitan area network, Internet network, or other similar type of network environment. The network 765 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 701 is a PC, workstation, intelligent device or the like, the software in the memory 710 may further include a basic input output system (BIOS) (omitted for simplicity). The BIOS is a set of essential software routines that initialize and test hardware at startup, start the OS 711, and support the transfer of data among the hardware devices. The BIOS is stored in ROM so that the BIOS can be executed when the computer 701 is activated.

When the computer 701 is in operation, the processor 705 is configured to execute software stored within the memory 710, to communicate data to and from the memory 710, and to generally control operations of the computer 701 pursuant to the software. The SAN cable identification methods described herein and the OS 711, in whole or in part, but typically the latter, are read by the processor 705, perhaps buffered within the processor 705, and then executed.

When the systems and methods described herein are implemented in software, as is shown in FIG. 7, the methods can be stored on any computer readable medium, such as storage 720, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the SAN cable identification methods are implemented in hardware, the SAN cable identification methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include but are not limited to enabling methods to identify individual active or loose cables or groups of cables eliminating a trial and error manual plug and re-plug process, as well is decreasing the time for cable identification and debugging. The systems and methods described herein can also provide a faster inventory process.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A cable apparatus, comprising:
a cable;
an identification adaptor disposed in the cable;
an illuminator disposed in the identification adaptor;
an endpoint adaptor disposed at an end of the cable; and
an integrated device disposed in the endpoint adapter and configured to generate a frequency in the cable.

2. The apparatus as claimed in claim 1 wherein the illuminator is a colorimeter.

3. The apparatus as claimed in claim 1 wherein the integrated device is a tunable diode.

4. The apparatus as claimed in claim 3 wherein the tunable diode generates a data transmission mode frequency and a identify mode frequency.

5. The apparatus as claimed in claim 4 wherein the data transmission mode frequency excites the illuminator to emit a first color and the identify mode frequency excites the illuminator to emit a second color.

6. The apparatus as claimed in claim 1 wherein the endpoint adapter is a gigabit interface controller (GBIC).

7. A cable system, comprising:
a first device;
a first endpoint adapter coupled to the first device;
a first integrated device disposed in the first endpoint adapter and configured to generate a first frequency in the cable;
a cable coupled to the first endpoint adapter;
an first identification adaptor disposed in the cable; and
a first illuminator disposed in the identification adapter.

8. The system as claimed in claim 7 wherein the first illuminator is a colorimeter.

9. The system as claimed in claim 7 wherein the first integrated device is a tunable diode.

10. The system as claimed in claim 9 wherein the tunable diode generates a data transmission mode frequency and a identify mode frequency.

11. The system as claimed in claim 10 wherein the data transmission mode frequency excites the illuminator to emit a first color and the identify mode frequency excites the illuminator to emit a second color.

12. The system as claimed in claim 7 wherein the endpoint adapter is a gigabit interface controller (GBIC).

13. The system as claimed in claim 13 further comprising a second endpoint adapter coupled to the cable.

14. The system as claimed in claim 13 further comprising a second device coupled to the second endpoint adapter.

15. The system as claimed in claim 13 further comprising a second integrated device disposed in the second endpoint adapter and configured to generate a second frequency in the cable.

16. The system as claimed in claim 7 further comprising a controller having a process including instructions for:
sending a data transmission mode command to generate a data transmission mode frequency in the cable;
sending and transmitting data with the data transmission mode frequency in the cable;
sending an identify mode command to generate an identify mode frequency in the cable; and
terminating sending and transmitting data in response to generating the identify mode frequency in the cable.

17. The system as claimed in claim 16 wherein the cable emits a first color in response to the data transmission mode frequency, and wherein the cable emits a second color in response to the identify mode frequency.

18. A cable identification method, comprising:
sending a data transmission mode command to generate a data transmission mode frequency in the cable;
sending and transmitting data with the data transmission mode frequency in the cable;
sending an identify mode command to generate an identify mode frequency in the cable; and
terminating sending and transmitting data in response to generating the identify mode frequency in the cable.

19. The method as claimed in claim 18 wherein the cable emits a first color in response to the data transmission mode frequency.

20. The method as claimed in claim 18 wherein the cable emits a second color in response to the identify mode frequency.
